(19) United States
(12) Patent Application Publication
(10) Pub. No.: US 2016/0304755 A1
(43) Pub. Date: Oct. 20, 2016

(54) MULTI-PHASE POLYMER COMPOSITION

(71) Applicant: TESA SE, Norderstedt (DE)

(72) Inventors: Marten PAPENBROOCK, Hamburg (DE); Alexander PRENZEL, Hamburg (DE)

(73) Assignee: TESA SE, Norderstedt (DE)

(21) Appl. No.: 15/100,776

(22) PCT Filed: Oct. 30, 2014
(86) PCT No.: PCT/EP2014/073305

§ 371 Date: Jun. 1, 2016

(30) Foreign Application Priority Data
Dec. 3, 2013 (DE) 10 2013 224 772.9

(51) Int. Cl. C09J 151/06; B32B 37/12; C08L 51/06

(52) U.S. Cl. CPC C09J 151/06; C08L 51/06; B32B 37/12; B32B 2309/02

(57) ABSTRACT

Multi-phase polymer composition comprising a comb polymer (A) which forms a continuous acrylate phase and a discontinuous hydrocarbon phase, and at least one hydrocarbon compound (B) which is soluble in the hydrocarbon phase of the comb polymer (A), an adhesive mass comprising the multi-phase polymer composition.

### TECHNICAL FIELD OF THE INVENTION

The present invention relates to a multiphase polymer composition comprising a comb-type graft copolymer (A) having a continuous acrylate phase and a discontinuous hydrocarbon phase, and also at least two hydrocarbon compounds (B-1) and (B-2), which are soluble in the hydrocarbon phase of said comb-type graft polymer (A), and also, optionally, further additives. The present invention further relates to pressure-sensitive adhesives comprising the multiphase polymer composition of the present invention and also to the method of using this pressure-sensitive adhesive for bonding articles, in particular for bonding articles having apolar surfaces. A method of preparing the multiphase polymer composition is likewise described.

### GENERAL PRIOR ART

Pressure-sensitively adhesive polymer compositions based on acrylates are known from the prior art. Acrylate-based adhesives are by virtue of their chemical resistance particularly suitable for bonding in industrial applications, and the polymer compositions described in the prior art are used to bond various substrates. However, known compositions are disadvantageous in that they are difficult to use with substrates having surfaces of low energy (i.e., “low surface energy” materials, hereinafter also referred to as “LSE” materials). This is reflected not only in the (low) bond strength of known pressure-sensitive adhesives on apolar substrates such as polypropylene or steel coated with LSE varnishes but also in the (low) speed at which the maximum bond strengths are attained. The main factor responsible for the low bond strengths of known acrylate-based pressure-sensitive adhesives on apolar surfaces is considered to be the difference in the surface energies of the known polymer compositions and of the LSE materials and also the absence of suitable points of attachment within the LSE surfaces for covalent or strong non-covalent bonds. Adhesion between known acrylate-based polymer compositions and LSE surfaces therefore essentially occurs through weaker van der Waals forces.

One approach to obtaining higher bond strengths between LSE surfaces and polymer compositions based on polyacrylates consists in the use of tackifying resins. Another approach utilizes so-called primers, i.e., adhesion promoters, to raise the surface energy of LSE substrates. While the deployment of primers is costly and inconvenient, the use of tackifying resins leads to a reduction in the cohesive strength of the polymer composition, which may cause the bond to break under load.

US 2010/0266837 A1 against this background discloses pressure-sensitive adhesives comprising a comb-type graft copolymer and a hydrocarbon compound having a molecular weight of at least 1000 g/mol. The results of these prior art pressure-sensitive adhesives still leave something to be desired, however, and there is a fundamental need for pressure-sensitive adhesives having good bond strengths on apolar surfaces without having to make compromises in respect of cohesive strength. Pressure-sensitive adhesives of this type should further evince chemical resistance and develop high bond strengths after just a short time.

### OBJECT OF THE PRESENT INVENTION

The present invention accordingly has for its object to provide an improved polymer composition.

### SUMMARY OF THE PRESENT INVENTION

The present invention addresses this object and the problems of the prior art by providing a multiphase polymer composition comprising
30-64 parts by weight, preferably 45-60 parts by weight, of a comb-type graft copolymer (A) which is obtainable by polymerizing a comonomer mixture in the presence of at least one macromer selected from the group consisting of polymerizable ethylene-butylene, ethylene-propylene, ethylene-butylene-propylene and isobutylene macromers, and which forms a continuous acrylate phase and a discontinuous hydrocarbon phase Kw;
36-70 parts by weight, preferably 40-55 parts by weight, of at least two hydrocarbon compounds (B-1) and (B-2) soluble in said hydrocarbon phase Kw of said comb-type graft copolymer (A);
and also, optionally, up to 20 parts by weight, preferably 0-5 parts by weight of further additives, based on 100 parts by weight of the polymer composition,
   wherein the comonomer mixture comprises: 2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method (measurement method A2), of more than 40° C., preferably more than 80° C.; and 43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method (measurement method A2) of 40° C. or less, preferably 25° C. or less, preferably selected from (meth)acrylate comonomers having a C1-C18 alkyl moiety in the ester group, more preferably butyl acrylate, amyl acrylate, 2-ethylhexyl acrylate, isooctyl acrylate and decyl acrylate; and
   wherein the at least two hydrocarbon compounds comprise a hydrocarbon resin (B-1) having a softening point of at least 70° C. and a hydrocarbon resin (B-2) having a softening point of at most 20° C.

The present invention further provides methods of preparing the multiphase polymer composition, said methods comprising the steps of
polymerizing a comonomer mixture in the presence of at least one macromer selected from the group consisting of polymerizable ethylene-butylene, ethylene-propylene, ethylene-butylene-propylene and isobutylene macromers to form a comb-type graft copolymer (A) having an acrylate main chain and hydrocarbon side chains, wherein the comonomer mixture comprises:
   2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method (measurement method A2), of more than 40° C., preferably more than 80° C.; and
   43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method (measurement method A2) of 40° C. or less, preferably 25° C. or less, preferably selected from (meth)acrylate comonomers having a C1-C18 alkyl moiety in the ester group, more preferably butyl acrylate, amyl acrylate, 2-ethylhexyl acrylate, isooctyl acrylate and decyl acrylate;
mixing 30-64 parts by weight of said comb-type graft copolymer (A) thus obtained with 36-70 parts by weight, based on 100 parts by weight of the polymer composition, of at least two hydrocarbon compounds (B-1) and (B-2) which are compatible with the hydrocarbon side chains of said comb-type graft copolymer (A), wherein (B-1) is a hydrocarbon resin having a softening point of at least 70° C. and (B-2) is a hydrocarbon resin having a softening point of at most 20° C.;
optionally mixing with further additives;
and also, optionally, the step of crosslinking reactive functional groups.

Comb-type graft copolymer (A) as described herein forms a continuous acrylate phase and a discontinuous hydrocarbon phase Kw as soon as a multiplicity of polymer chains of individual comb-type graft copolymer molecules come into contact with one another, for example after a solvent has been removed. Association occurs of the acrylate main chains and the hydrocarbon side chains so as to form a continuous acrylate phase and a discontinuous hydrocarbon phase.

The multiphase polymer compositions of the present invention comprise at least two phases, namely at least a hydrocarbon phase Kw1 and an acrylate phase. Evidence for the presence of these phases is derivable from determining the static glass transition temperatures of the polymer composition by means of DSC. Alternatively or additionally, the presence of the different phases can be evidenced by means of dynamic mechanical analysis (DMA) (measurement method A3). A so-called temperature sweep measurement here will detect two or more glass transitions resulting from the individual constituents of the composition. Owing to the particular combination of the comb-type graft copolymer (A) and the hydrocarbon compounds (B-1) and (B-2) in the abovementioned ratios, the composition is stable despite the different phases, in that it does not undergo any macroscopic type of phase separation into the comb-type graft copolymer (A) on the one hand and the hydrocarbon compounds (B-1) and (B-2) on the other.

The multiphase polymer compositions of the present invention will prove particularly useful in the bonding of articles having LSE surfaces. They are further chemically and UV resistant and are highly cohesive not only at room temperature (25° C.) but also at high temperatures, which shows in high levels of shear strength. Surprisingly, the polymer compositions nonetheless wet out rapidly on surfaces of low-energy articles, on surfaces coated with LSE varnishes and also on other LSE materials, which makes possible the development of high levels of bond strength within a short time. The multiphase polymer compositions of the present invention are further useful in providing pressure-sensitive adhesives that are transparent. In a further aspect, the present invention accordingly provides pressure-sensitive adhesives, preferably transparent pressure-sensitive adhesives, comprising the multiphase polymer composition described herein. The present invention further provides the method of using the pressure-sensitive adhesive to bond articles, in particular to bond articles having low surface energies (LSE materials). LSE materials for the purposes of the present invention also comprehend materials which are actually not LSE materials, but whose surfaces behave like LSE materials with respect to adhesives by reason of a coating, e.g., with a layer of an LSE varnish.

### DETAILED DESCRIPTION OF THE INVENTION

The object described above is achieved according to the invention by a multiphase polymer composition comprising
30-64 parts by weight, preferably 45-60 parts by weight, of a comb-type graft copolymer (A) which is obtainable by polymerizing a comonomer mixture in the presence of at least one macromer selected from the group consisting of polymerizable ethylene-butylene, ethylene-propylene, ethylene-butylene-propylene and isobutylene macromers, and which forms a continuous acrylate phase and a discontinuous hydrocarbon phase Kw;
36-70 parts by weight, preferably 40-55 parts by weight of at least two hydrocarbon compounds (B-1) and (B-2) soluble in said hydrocarbon phase Kw of said comb-type graft copolymer (A);
and also, optionally, up to 20 parts by weight, preferably 0-5 parts by weight of further additives, based on 100 parts by weight of the polymer composition,
   wherein the comonomer mixture comprises: 2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method (measurement method A2), of more than 40° C., preferably more than 80° C.; and 43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method (measurement method A2) of 40° C. or less, preferably 25° C. or less, preferably selected from (meth)acrylate comonomers having a C1-C18 alkyl moiety in the ester group, more preferably butyl acrylate, amyl acrylate, 2-ethylhexyl acrylate, isooctyl acrylate and decyl acrylate; and
   wherein the at least two hydrocarbon compounds comprise a hydrocarbon resin (B-1) having a softening point of at least 70° C. and a hydrocarbon resin (B-2) having a softening point of at most 20° C.

In one preferred embodiment, the polymer composition described herein is characterized in that said comb-type graft copolymer (A) is obtainable via polymerization from a mixture comprising 50-99 weight percent of the comonomer mixture and also 1-50 weight percent of the macromer, preferably 75-95 weight percent of the comonomer mixture and also 5-25 weight percent of the macromer, more preferably 85-90 weight percent of the comonomer mixture and also 10-15 weight percent of the macromer, based on the combined weight of the comonomer mixture and of the at least one macromer.

In a further embodiment of the invention, the polymer composition further comprises a hydrocarbon compound (C) whose number-average molecular weight (Mn) is more than 1000 g/mol. In a further embodiment, the polymer composition comprises at least one additive selected from the group consisting of plasticizers, oils and resins which are soluble in the acrylate phase of the comb-type graft copolymer (A), preferably rosin esters and/or terpene-phenolic resins.

In a second aspect, the present invention provides methods of preparing a multiphase polymer composition as claimed in any preceding claim, which methods comprise the steps of
polymerizing a comonomer mixture in the presence of at least one macromer selected from the group consisting of polymerizable ethylene-butylene, ethylene-propylene, ethylene-butylene-propylene and isobutylene macromers to form a comb-type graft copolymer (A) having an acrylate main chain and hydrocarbon side chains, wherein the comonomer mixture comprises:
   2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method (measurement method A2), of more than 40° C., preferably more than 80° C.; and
   43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method (measurement method A2) of 40° C. or less, preferably 25° C. or less, preferably selected from (meth)acrylate comonomers having a C1-C18 alkyl moiety in the ester group, more preferably butyl acrylate, amyl acrylate, 2-ethylhexyl acrylate, isooctyl acrylate and decyl acrylate;
mixing 30-64 parts by weight of said comb-type graft copolymer (A) thus obtained with 36-70 parts by weight, based on 100 parts by weight of the polymer composition, of at least two hydrocarbon compounds (B-1) and (B-2) which are compatible with the hydrocarbon side chains of said comb-type graft copolymer (A), wherein (B-1) is a hydrocarbon resin having a softening point of at least 70° C. and (B-2) is a hydrocarbon resin having a softening point of at most 20° C.;
optionally mixing with further additives;
and also, optionally, the step of crosslinking reactive functional groups.

The present invention further provides pressure-sensitive adhesives comprising a multiphase polymer composition as described herein and also the method of using said pressure-sensitive adhesive to bond articles, in particular articles having surfaces with a low surface energy (LSE materials).

In what follows, the components of the polymer composition according to the present invention and of the pressure-sensitive adhesive comprising said polymer composition are more particularly described.

### Comb-Type Graft Copolymer (A)

Comb-type graft copolymers are polymers with a construction characteristic in that on their main chain (polymer backbone) they carry side chains which by virtue of their length might already be considered to be polymeric.

As used herein, the comb-type graft copolymer (A) is intended to stand for a copolymer which more particularly is obtainable by free radical polymerization of a comonomer mixture in the presence of at least one macromer selected from the group consisting of polymerizable ethylene-butylene, ethylene-propylene, ethylene-butylene-propylene and isobutylene macromers.

### Comonomer Mixture

The comonomer mixture which, as described herein, is polymerized in the presence of the at least one macromer to form the comb-type graft copolymer (A) comprises 2-7, preferably 2-6, more preferably 3-5 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further (so-called high-Tg) monomers whose homopolymers have a static glass transition temperature (Tg), as measured by the DSC method (measurement method A2) of more than 40° C., preferably more than 80° C. The comonomer mixture further comprises 43-97, preferably 70-95, more preferably 80-87 weight percent, based on the combined weight of the comonomer mixture and of the at least one macromer, of at least two (meth)acrylate comonomers selected from the group consisting of (so-called low-Tg) monomers whose homopolymers have a static glass transition temperature (Tg), as measured by the DSC method (measurement method A2), of 40° C. or less, preferably 25° C. or less, preferably selected from (meth)acrylate comonomers having a C1-C18 alkyl moiety in the ester group, preferably butyl acrylate, amyl acrylate, 2-ethylhexyl acrylate, isooctyl acrylate and decyl acrylate. In one preferred embodiment of the invention, the comonomer mixture comprises 2-7 weight percent, based on the combined weight of the comonomer mixture and of the at least one macromer, of at least one comonomer selected from the group consisting of acrylic acid, methacrylic acid, itaconic acid, itaconic anhydride, maleic acid and maleic anhydride and also 43-97 weight percent, based on the combined weight of the comonomer mixture and of the at least one macromer, of at least two (meth)acrylate comonomers selected from the group consisting of (meth)acrylate comonomers having a C1-C18 alkyl moiety in the ester group, preferably butyl acrylate, amyl acrylate, 2-ethylhexyl acrylate, isooctyl acrylate and decyl acrylate.

In other words, the comonomer mixture consists of at least three comonomers, of which one is selected from the group consisting of acrylic acid, methacrylic acid, itaconic acid, itaconic anhydride, maleic acid, maleic anhydride and further monomers whose homopolymers have a static glass transition temperature (Tg), measured by the DSC method, of more than 40° C., preferably more than 80° C. (also referred to below as “high-Tg” comonomer). The expression “high-Tg” monomer is based on the static glass transition temperature of the homopolymers as described in J. Brandrup, E. H. Immergut, E. A. Grulke, Polymer Handbook, 4th Edition, 1998. The comonomer mixture preferably comprises only one of these high-Tg comonomers, more preferably acrylic acid or methacrylic acid, preferably acrylic acid. In accordance with the invention, this high-Tg comonomer is used in an amount of 2-7 weight percent, based on the total weight of the comonomer mixture and of the at least one macromer, preferably in an amount of 2-6, more preferably in an amount of 3-5 weight percent.

The at least two (meth)acrylate comonomers which form part of the comonomer mixture described herein are selected from the group consisting of monomers whose homopolymers have a static glass transition temperature (Tg), as measured by the DSC method, of 40° C. or less, preferably 25° C. or less (hereinafter also referred to as “low-Tg comonomers”). The expression “low-Tg monomer” is based on the static glass transition temperature of homopolymers as described in J. Brandrup, E. H. Immergut, E. A. Grulke, Polymer Handbook, 4th Edition, 1998. The at least two (meth)acrylate comonomers are preferably selected from (meth)acrylate comonomers having a C1-C18 alkyl moiety in the ester group, preferably having a C4-C10 alkyl moiety in the ester group. Preferred examples of these low-Tg comonomers are butyl acrylate, amyl acrylate, 2-ethylhexyl acrylate, isooctyl acrylate and decyl acrylate and also isomers thereof. Particular preference is given to using butyl acrylate, 2-ethylhexyl acrylate, isooctyl acrylate and/or decyl acrylate. Particular preference is given to selecting at least one of the at least two (meth)acrylate comonomers from monomers whose homopolymers have a static glass transition temperature (Tg) of 0° C. or less. This at least one of the at least two (meth)acrylate comonomers is preferably butyl acrylate, 2-ethylhexyl acrylate, isooctyl acrylate or decyl acrylate.

In a further embodiment the comonomer mixture additionally comprises up to 20 weight percent, preferably up to 15 weight percent (based on the total weight of the comonomer mixture and of the at least one macromer), of at least one further copolymerizable monomer, selected from the group consisting of isobornyl acrylate, stearyl acrylate, isostearyl acrylate, hydroxyethyl acrylate, hydroxyethyl methacrylate, 4-hydroxybutyl acrylate, vinyl acetate, vinyl butyrate, vinyl propionate, vinyl isobutyrate, vinyl valerate, vinyl versatate, N-vinylpyrrolidone and N-vinylcaprolactam, preferably selected from isobornyl acrylate, stearyl acrylate, isostearyl acrylate, vinyl acetate, vinyl butyrate, vinyl propionate, vinyl isobutyrate, vinyl valerate, vinyl versatate, N-vinylpyrrolidone and N-vinylcaprolactam.

In one particularly preferred embodiment, the comonomer mixture does not comprise any hydroxyalkyl (meth)acrylates. The inventors are of the view that comonomer mixtures which do not comprise any hydroxyalkyl (meth)acrylates are particularly suitable for the provision of advantageous comb-type graft copolymers (A).

The individual comonomers of the comonomer mixture are preferably selected such that the polyacrylate backbone (also referred to as “acrylate backbone”, “polyacrylate main chain”, “acrylate main chain” or “main chain”), i.e., the continuous acrylate phase of the comb-type graft copolymer (A), has a static glass transition temperature (as measured by the DSC method) of less than −10° C., preferably from −60° C. to −20° C.

Particularly preferred comonomer mixtures contain acrylic acid, butyl acrylate, 2-ethylhexyl acrylate and isobornyl acrylate, more preferably acrylic acid, butyl acrylate and 2-ethylhexyl acrylate.

Exemplary preferred comonomer mixtures consist of 3-7 weight percent acrylic acid, 45-65 weight percent butyl acrylate, 20-27 weight percent 2-ethylhexyl acrylate and up to 15 weight percent isobornyl acrylate, the figures in weight percent being based on the total weight of the comonomer mixture and of the at least one macromer.

### Macromer

The comonomer mixture is polymerized in the presence of at least one macromer to form a comb-type graft copolymer (A). Macromers are polymers of relatively low molecular mass, having a reactive, copolymerizable functional group at one or more ends of the polymer. The at least one macromer is selected from the group consisting of polymerizable ethylene-butylene, ethylene-propylene, ethylene-butylene-propylene and isobutylene macromers. The macromer main chains of these ethylene-butylene, ethylene-propylene, ethylene-butylene-propylene and isobutylene macromers are preferably fully hydrogenated. They are obtainable by means of anionic polymerization of the corresponding monomers. One known process, for example, comprises anionic polymerization to prepare hydroxyl-terminated, conjugated diene polymers of monomers such as 1,3-butadiene and/or isoprene. Suitable rubber-like monools such as Kraton® L 1203 are available from Kraton Polymers Company. In a subsequent step, the terminal hydroxyl function can be reacted to form an acryloyl or methacryloyl functionality.

In accordance with the invention, the macromer has a molecular weight of preferably 2000 to about 30 000 g/mol, more preferably 2000 to 10 000 g/mol (measured by means of gel permeation chromatography (GPC), polystyrene as standard, measurement method A1). In one preferred embodiment of the invention, the macromer has a glass transition temperature as measured by the DSC method of −30° C. or less, preferably of −70° C. to −50° C. Such macromers are available commercially, from Kuraray Co., Ltd., for example. One preferred macromer is L-1253 from Kuraray Co., Ltd. Macromers as used herein are polymers of relatively low molecular mass with a functional, copolymerizable reactive group, more particularly an acrylate-functional or methacrylate-functional group, at one or more ends of the polymer.

The comb-type graft copolymer (A) is formed by preferably free radical polymerization of the comonomer mixture in the presence of the at least one macromer. Comb-type graft copolymer (A) is a comblike graft copolymer. The term “graft copolymer” in this context, however, is misleading in that in the present instance the comb-type graft copolymer can be formed by polymerization of comonomers of the comonomer mixture in the presence of the macromer molecules. Instead, therefore, of graft copolymerization, in which an existing polymer backbone serves as a point of attachment for chains of further monomers, the side chains of the comb-type graft copolymer (A) as used herein are preferably introduced during the polymerization of the comonomers with the copolymerizable reactive groups of the macromer, preferably with the acrylate-functional or methacrylate-functional groups of the macromer, via the macromer chains. The copolymerizable reactive groups of the macromer, accordingly, are incorporated into the polyacrylate backbone (main chain) during the actual polymerization of the comonomer mixture. The ethylene-butylene, ethylene-propylene, ethylene-butylene-propylene and/or isobutylene chains of the macromer form the side chains of the comb-type graft copolymer (A) (also referred to herein as hydrocarbon side chains of the comb-type graft copolymer (A)). On the basis of its structure, the comb-type graft copolymer (A) is also referred to as a “bottle brush” polymer. Within the polymer composition of the invention, this structure and the lipophilic nature of the hydrocarbon side chains result in the formation of a continuous acrylate phase and of a discontinuous hydrocarbon phase Kw of the comb-type graft copolymer (A). The hydrocarbon phase Kw is preferably in microphase-separated form. It is thought that the phase-separated, preferably microphase-separated, comb-type graft copolymer (A) unites different physical properties by virtue of the development of the continuous acrylate phase and the discontinuous hydrocarbon phase, these properties being, specifically, a rubber-like—that is, in the present case, a hydrophobic, thermoplastic—character of the side chains, with the inherently pressure-sensitively adhesive properties of the polyacrylate backbone.

The fraction of the at least one macromer is preferably 1 to 50 weight percent, more preferably 5 to 25 weight percent and still more preferably 10 to 15 weight percent, based on the total weight of comonomer mixture and the at least one macromer.

In another preferred embodiment, the polymerization of the comonomer mixture is carried out in the presence of at least one further, non-polyolefinic macromer. This additional non-polyolefinic macromer is preferably selected from the group of the polymethylacrylates, polystyrenes, polydimethylsiloxanes, polyethylene oxides and polypropylene oxides. These further non-polyolefinic macromers are also copolymerizable macromers. In other words, these non-polyolefinic macromers as well preferably have a functional acrylate or methacrylate group at the end of the polymer chain of the macromer. In one embodiment of the invention, the fraction of the at least one further, non-polyolefinic macromer is up to 20, preferably up to 10, more preferably up to 5 weight percent, based on the total weight of the comonomer mixture and the macromers.

### Hydrocarbon Compounds (8-1) and (8-2)

The multiphase polymer composition comprises at least two hydrocarbon compounds (B-1) and (B-2), which are soluble in the hydrocarbon phase of the comb-type graft copolymer (A). The expression “soluble” in this context is to be understood as meaning that the hydrocarbon compounds (B-1) and (B-2) are compatible with the hydrocarbon side chains of the comb-type graft copolymer (A), and therefore a conjoint hydrocarbon phase Kw1 consisting of the hydrocarbon side chains of the comb-type graft copolymer (A) and of the hydrocarbon compounds (B-1) and (B-2), is formed within the polymer composition. The presence of this conjoint hydrocarbon phase is verifiable using a DSC method: if the composition consisting of comb-type graft copolymer (A) and hydrocarbon compounds (B-1) and (B-2) differs in the DSC measurement merely in the magnitudes of the static glass transition temperatures from said comb-type graft copolymer (A) prior to the addition of compounds (B-1) and (B-2), there is no additional phase in the sense of a phase that could have been detected via an additional static glass transition temperature. On the contrary, the hydrocarbon phase Kw1 of the polymer composition is characterized via its static glass transition temperature Tg(Kw1). Accordingly, the acrylate phase within the polymer composition, whereto the acrylate backbone of comb-type graft copolymer (A) makes a contribution, is also quantifiable in terms of its glass transition temperature (Tg(Ac)) by means of DSC.

Hydrocarbon compound (B-1) comprises a hydrocarbon resin having a softening point of at least 70° C., preferably 70 to 150° C., more preferably 80 to 120° C. Hydrocarbon compound (B-2) is a hydrocarbon resin having a softening point of at most 20° C. The respective softening points of hydrocarbon resins (B-1) and (B-2) are ring & ball softening points (as measured to ASTM E28-99). The hydrocarbon resin (B-1), having a softening point of at least 70° C., is hereinafter also referred to as “hard resin”. The hydrocarbon resin (B-2), having a softening point of at most 20° C., is hereinafter also referred to as “soft resin”.

In a preferred embodiment, hydrocarbon resin (B-1) and/or hydrocarbon resin (B-2) has a number average molecular weight (Mn) (determined by GPC, method A1) of 1000 g/mol or less. Hydrocarbon resins (B-1) and (B-2) are preferably in a (B-1):(B-2) weight ratio of 41:59 to 70:30. In a particularly preferred embodiment of the invention, the proportion of hydrocarbon resin (B-1) having a softening point of at least 70° C. is between 41 and 70 weight percent, more preferably between 50 and 60 weight percent, based on the total amount of all hydrocarbon resins in the multiphase polymer composition.

Suitable hard resins are petroleum-based synthetic hydrocarbons. Examples include resins based on aliphatic olefins. Such resins are available from Cray Valley under the Wingtack® 95 name, from Exxon under the Escorez® trade name, from Arakawa Chemical under the Arkon® (P series) trade name, from Hercules Speciality Chemicals under the Regalrez® (1030, 2000 and 5000 series) trade name and under the Regalite® (R series) name, and from Yasuhara Yushi Kogyo Company under the Clearon® trade name.

Suitable soft resins are the C5 resin Wingtack® 10 from Cray Valley, the polyterpene resin Dercolyte® LTG and the fully hydrogenated hydrocarbon resins Regalite® 1010 and Piccotac® 1020.

In a further embodiment of the invention, the proportion of the polymer composition hydrocarbon phase, the Tg of which, Tg(Kw1), is DSC determinable, which is attributable to the at least two hydrocarbon compounds (B-1) plus (B-2) soluble in the hydrocarbon phase of comb-type graft copolymer (A) is at least 80 weight percent based on the weight fraction of the polymer composition which is attributable to the hydrocarbon phase, i.e., based on the amount of hydrocarbon side chains of comb-type graft copolymer (A) and of the hydrocarbon resins (B-1) and (B-2).

Surprisingly, the hydrocarbon resins (B-1) and (B-2) turned out to be suitable for providing particularly advantageous polymer compositions when said hydrocarbon compounds (B-1) and (B-2) are present in a proportion of 36 to 70 parts by weight, preferably 40 to 45 parts by weight, based on 100 parts by weight of the polymer composition. When high proportions of the polymer composition are attributable to hydrocarbon compound (B-2), an additional hydrocarbon phase may be formed within the acrylate phase. One possible explanation for this is that the soft resin (B-2) is admixed in an amount exceeding the solubility limit of hydrocarbon compound (B-2) within the hydrocarbon phase of comb-type graft copolymer (A). This additional hydrocarbon phase is detectable, for example by dynamic mechanical analysis (DMA) (measurement method A3).

### Additives and Tackifier Resins

Aside from comb-type graft copolymer (A) and hydrocarbon compounds (B-1) and (B-2), the polymer composition may comprise at least one additive and/or tackifier resin. Additives as used herein comprise plasticizers, oils, and resins which are soluble in the acrylate phase of the comb-type graft copolymer (A), preferably rosin esters and/or terpene-phenolic resins. Preferred rosin esters are hydrogenated rosin esters. Preferred terpene-phenolic resins are ageing-resistant terpene-phenolic resins.

It is likewise possible to mix one or more tackifier resins other than hydrocarbon compounds (B-1) and (B-2). If present, additives and tackifier resins are preferably in an amount of up to 20 parts by weight, preferably up to 5 parts by weight, based on 100 parts by weight of the polymer composition.

In a further preferred embodiment, the polymer composition comprises an additional hydrocarbon compound (C) whose number average molecular weight (Mn) is more than 1000 g/mol. This additional hydrocarbon compound (C) is preferably a further soft resin. In one particular embodiment of the invention, the hydrocarbon compound (C) forms a discontinuous phase within the acrylate phase of the polymer composition. In other words, this particular embodiment comprises two different discontinuous phases within the continuous phase of the polymer composition. In this embodiment, the static glass transition temperature of this additional phase within the polymer composition, Tg (C), is intermediate the glass transition temperatures Tg(Kw1) and Tg(Ac) of the polymer composition.

It is further possible to use aging inhibitors, light stabilizers and ozone protectants as additives. Aging inhibitors used may be Irganox® products from BASF or Hostanox® from Clariant, preferably primary inhibitors, examples being 4-methoxyphenol or Irganox® 1076, and secondary aging inhibitors, examples being Irgafos® TNPP or Irgafos® 168 from BASF, including in combination with one another. Other suitable aging inhibitors are phenothiazine (C radical scavenger) and also hydroquinone methyl ether in the presence of oxygen, and oxygen itself. Light stabilizers used may be UV absorbers (Cyasorb® series) or sterically hindered amines (Tinuvin® series).

### Preparation of Multiphase Polymer Compositions

The polymer compositions of the present invention are obtainable by first polymerizing the comonomer mixture described herein in the presence of the at least one macromer, selected from the group consisting of polymerizable ethylene-butylene, ethylene-propylene, ethylene-butylene-propylene and isobutylene macromers, to form the comb-type graft copolymer (A). The comb-type graft copolymer (A) here may be prepared by conventional polymerization techniques familiar to the skilled person. These processes include solution, suspension, emulsion and bulk polymerization processes. The comb-type graft copolymers (A) are preferably prepared in solution by free radical polymerization. Preferred solvents and solvent mixtures ensure sufficient solubility of the macromers and are ethyl acetate, acetone, methyl isopropyl ketone, hexane and/or heptane, and also toluene, and mixtures of the stated solvents. In one preferred embodiment of the invention, the residual monomer content is reduced after the polymerization, using known methods from the prior art.

Following removal of the solvent (where present), the acrylate backbone and the hydrocarbon side chains of the comb-type graft copolymer are present in the form of a phase-separated structure, preferably a microphase-separated structure, in which the hydrocarbon phase Kw1, which is formed from the hydrocarbon side chains of the comb-type graft copolymer (A) and the hydrocarbon compounds (B-1) and (B-2) soluble in this hydrocarbon phase, is present discontinuously in the continuous acrylate phase of the polymer composition. Continuously in this context means that the acrylate phase envelops the individual sections of the discontinuous hydrocarbon phase (also called domains) like a matrix. The presence of a microphase-separated structure is manifested in the form of a transparent appearance to the polymer composition. In such a polymer composition, the domains of the hydrocarbon phase have a size which is below the wavelength of visible light (390-780 nm).

### Pressure-Sensitive Adhesive

The present invention further provides pressure-sensitive adhesives comprising the polymer composition of the present invention. Surprisingly, the pressure-sensitive adhesives were found to be particularly suitable for bonding substrates having apolar surfaces. Yet the pressure-sensitive adhesives of the present invention are still suitable for bonding polar surfaces. Apolar surfaces are substrates having a low surface energy or low surface tension, in particular a surface tension of less than 45 mN/m, preferably less than 40 mN/m and more preferably less than 35 mN/m. Surface tension is determined by measuring the contact angle to DIN EN 828.

The pressure-sensitive adhesive of the present invention is preferably provided in film form. For this purpose, the polymer composition, either as such or after addition of tackifier resins, may be formed via commonly used coating methods from a solution into a layer of pressure-sensitive adhesive on a carrier material (film, foam, syntactic foam, fabric, paper), the layer of pressure-sensitive adhesive having a weight per unit area of 40 to 100 g/m2.

Adhesive tapes of the invention may take any of the following forms:
single-layer, double-sidedly self-adhesive tapes—known as “transfer tapes”-comprising a single layer of the pressure-sensitive adhesive of the invention or the multiphase polymer composition of the invention;
single-sidedly self-adhesively furnished adhesive tapes—“single-sided self-adhesive tapes” hereinafter—where the pressure-sensitive adhesive of the invention or the multiphase polymer composition of the invention is provided in a multilayer product, examples being two-layer systems comprising a layer of the pressure-sensitive adhesive of the invention or of the multiphase polymer composition of the invention and a foamed or unfoamed carrier layer,
multilayer, double-sidedly self-adhesively furnished adhesive tapes having two pressure-sensitive adhesive layers—“double-sided self-adhesive tapes” below—of which at least one comprises the multiphase polymer composition of the invention,
double-sided adhesive tapes having a heat-activatable adhesive layer on one of the adhesive-tape sides and a layer of the pressure-sensitive adhesive of the invention or the multiphase polymer composition of the invention on the other adhesive-tape side. To this end, the two layers can be applied to different sides of at least one foamed or unfoamed carrier or to different sides of a multilayered system.

The double-sided products here, irrespective of whether they are intended for adhesive bonding or for sealing, may have a symmetrical or asymmetrical construction.

The adhesive tape is preferably provided, on one side at least, a liner, i.e., for example a silicone-coated film or a silicone paper, for transportation, storage or die-cutting processes.

The invention will now be more particularly described by means of specific examples.

### Experimental Section

The exemplary experiments which follow are intended to more particularly describe the invention without the invention being unnecessarily restricted by the choice of the examples disclosed.

### Measurement Methods (General):

### Gel Permeation Chromatography GPC (Method A1):

The figures in this specification for the number-average and weight-average molecular weights Mₙ and M_{w}, and the polydispersity PD relate to the determination by gel permeation chromatography. The determination takes place on 100 μL samples subjected to clarifying filtration (sample concentration 4 g/L). The eluent used is tetrahydrofuran with 0.1 vol % of trifluoroacetic acid. Measurement takes place at 25° C. The preliminary column used is a PSS-SDV column, 5μ, 10³ Å, ID 8.0 mm×50 mm. Separation takes place using the columns PSS-SDV, 5μ, 10³ Å and also 10⁵ Å and 10⁶ Å, each of ID 8.0 mm×300 mm (columns from Polymer Standards Service; detection using Shodex RI71 differential refractometer). The flow rate is 1.0 mL per minute. Calibration takes place against PMMA standards (polymethyl methacrylate calibration) in the case of the comb-type graft copolymers and PS standards (polystyrene calibration) in the case of the hydrocarbon resins.

### Static Glass Transition Temperature Tg (Measurement Method A2):

The static glass transition temperature is determined by dynamic scanning calorimetry in accordance with DIN 53765. The figures given for the glass transition temperature Tg relate to the glass transformation temperature value Tg according to DIN 53765:1994-03, unless indicated otherwise specifically.

### Dynamic Mechanical Analysis (DMA) (Measurement Method A3):

The test is run in a shear rate controlled rheometer from Ares under torsional load using a plate-plate geometry with a plate diameter of 25 mm. The temperature sweep measurement is carried out using a measurement frequency of 10 rad/s, a temperature range of −40° C. to 130° C., a heating rate of 2.5° C./min and a deformation of 1%.

### Solids Content (Measurement Method A4):

The solids content is a measure of the fraction of unevaporable constituents in a polymer solution. It is determined gravimetrically, with the solution being weighed, then the vaporizable fractions being evaporated off in a drying cabinet at 120° C. for 2 hours, and the residue weighed again.

### Measurement Methods (for Pressure-Sensitive Adhesives in Particular):

### 180° Bond Strength Test (Measurement Method H1):

The bond strength to steel is determined in a test atmosphere of 23° C.+/−1° C. temperature and 50%+/−5% rel. humidity.

A strip 20 mm wide of an acrylate-type pressure-sensitive adhesive applied to polyester in the form of a layer was applied to steel plates washed beforehand with acetone twice and with isopropanol once and then let lie exposed to the air for 5 minutes in order that the solvent may flash off. The pressure-sensitively adhesive strip was pressed twice onto the substrate with an applied pressure corresponding to a weight of 2 kg. The adhesive tape was then immediately peeled off the substrate at a speed of 300 mm/min and at an angle of 180°. The measurements were all conducted at room temperature.

The measured results are reported in N/cm as averages of three measurements. The bond strength to polyethylene (PE) and varnish was determined in a similar manner. The varnish used in each case was Uregloss® Colorless varnish (product No. FF79-0060 0900) from BASF.

### Holding Power (Measurement Method H2):

A strip of the adhesive tape 13 mm wide and more than 20 mm (30 mm for example) in length was applied to a smooth steel surface cleaned three times with acetone and once with isopropanol. The bonding area is 20 mm×13 mm (length×width), and the adhesive tape overhangs the test plate at the edge (for example by 10 mm in accordance with the above-specified length of 30 mm). The adhesive tape was then pressed down four times on the steel support with an applied pressure corresponding to a weight of 2 kg. This sample was suspended vertically so that the overhanging edge of the adhesive tape points downwardly.

At room temperature, a weight of 1 kg was fastened to the overhanging edge of the adhesive tape. The measurement is carried out under standard conditions (23° C.+/−1° C., 55%+/−5% humidity) and at 70° C. in a thermal cabinet while the sample was subjected to the load of 0.5 kg weight.

The measured holding times (times of the adhesive tape to completely debond from the substrate; measurement discontinued at 10 000 min) are reported in minutes and correspond to the mean value of three measurements.

### Commercially Available Chemicals Used

| Chemical compound | Trade name | Manufacturer | CAS No. |
|---|---|---|---|
| 1,3-butadiene, homo- | L-1253 | Kuraray | 260057-97-4 |
| polymer, hydrogenated, | | | |
| hydroxyl terminated, | | | |
| monomethacrylate | | | |
| 2,2′-azobis(2- | Vazo ® 67 | DuPont | 13472-08-7 |
| methylbutyronitrile) | | | |
| bis(4-tert-butylcyclo- | Perkadox ® | Akzo Nobel | 15520-11-3 |
| hexyl) peroxy- | 16 | | |
| dicarbonate | | | |
| hydrocarbon resin | Piccotac ® | Eastman | — |
| (C₅ based, low | 1095-N | | |
| aromatics content, | | | |
| softening point (ring | | | |
| & ball) 94° C.) | | | |
| hydrocarbon resin | Reagalite ® | Eastman | — |
| (hydrogenated, | R1090 | | |
| softening point (ring | | | |
| & ball) 88° C.) | | | |
| liquid hydrocarbon | Wingtack ® | Cray Valley | 26813-14-9 |
| resin (C₅ based) | 10 | | |
| terpene-phenolic | Dertophene ® | DRT resins | 25359-84-6 |
| resin (softening point | T110 | | |
| 110° C.; M_{w} = 500-800 | | | |
| g/mol; D = 1.50) | | | |
| Aluminum acetyl- | — | Sigma-Aldrich | 13963-57-0 |
| acetonate | | | |
| N,N,N′,N′-tetrakis(2,3- | Erisys ™ | CVC Speciality | 63738-22-7 |
| epoxy-propyl)m-xylene- | GA-240 | Chemicals Inc. | |
| a,a′-diamine | | | |

### Preparation of Comb-Type Qraft Copolymers (A)—P1 to P6 and Comparative Example P7

The preparation of exemplary comb-type graft copolymers (A) will now be described.

### Example P1

A 100 L glass reactor conventional for radical polymerizations was charged with 1.2 kg of acrylic acid (AA, 3%), 20.97 kg of butyl acrylate (BA, 52.43%), 9.83 kg of 2-ethylhexyl acrylate (EHA, 24.57%), 4.0 kg of isobornyl acrylate (IBOA, 10%), 4.0 kg of macromer L-1253 (10%) and 20.8 kg of acetone/60/95 spirit (1:1). After nitrogen gas had been passed through the reactor for 45 minutes, with stirring, the reactor was heated up to 58° C. and 0.8 kg of Vazo® 67 was added. Thereafter the external heating bath was heated to 75° C. and the reaction was carried out constantly at this external temperature. After a reaction time of 1 hour, a further 0.8 kg of Vazo® 67 was added. Over a period of 5 hours (counted from the last addition of Vazo® 67), dilution took place at hourly intervals with 5.0 to 10.0 kg, depending on the rise in viscosity, of 60/95 spirit, and so adequate mixing was ensured. In order to reduce the level of residual monomers, additions of 1.5 kg each time of bis(4-tert-butylcyclohexyl) peroxydicarbonate were made after 6 hours and after 7 hours from the start of reaction, with dilution in between with 15 kg of 60/95 spirit. After a reaction time of 24 hours, the reaction was discontinued by cooling to room temperature.

### Comb-Type Graft Copolymers (A)—P2 to P6 and Comparative Example P7

Comb-type graft copolymers P2 to P6 and Comparative Example VP7 were prepared similarly to Example P1. Mass percentages of the monomers used in each case are itemized in table 1.

TABLE 1
Hybrid polymers P2 to P6 and Comparative Examples VP7

| | | | | | | Comparative |
|---|---|---|---|---|---|---|
| | 2 | 3 | 4 | 5 | 6 | Example VP7 |
| AA | 3.0% | 3.0% | 3% | 5.0% | 7% | 8% |
| BA | 60.1% | 56.6% | 49% | 54.5% | 53% | 52% |
| EHA | 26.9% | 25.4% | 23% | 25.5% | 25% | 25% |
| IBOA | — | — | 15% | — | — | — |
| L-1253 | 10.0% | 15.0% | 10% | 15.0% | 15% | 15% |

Table 2 shows the molar mass distributions as measured by GPC and the static glass transition temperatures of comb-type graft copolymers P1 to P6 and of Comparative Example VP7 as measured by DSC.

TABLE 2
Polymer data of polymers P1 to P6 and Comparative Example VP7

| | Mₙ | M_{w} | PD | stat. Tg |
|---|---|---|---|---|
| | [g/mol]^{b)} | [g/mol]^{b)} | [—]^{b)} | [° C.]^{c)} |
| P 1 | 63 800 | 1 640 000 | 25.71 | −37 |
| P 2 | 63 900 | 1 650 000 | 25.85 | −48 |
| P 3 | 58 700 | 1 670 000 | 28.44 | −48 |
| P 4 | 64 100 | 1 620 000 | 25.27 | −33 |
| P 5 | 78 800 | 1 690 000 | 21.48 | −34 |
| P 6 | 68 700 | 1 590 000 | 23.14 | −28 |
| VP7 | 62 100 | 1 550 000 | 24.96 | −27 |

^{b)}as measured by measurement method A1.
^{c)}as measured by measurement method A2.
The glass transition temperature of the hydrocarbon phase of the comb-type graft copolymers could not be determined, since it is below the −50° C. starting temperature of the measurement.

### II Preparation of Multiphase Polymer Compositions PSA1 to PSA10 and of Comparative Examples V11 and V12

Multiphase polymer compositions PSA1 to PSA10 and also V11 and V12 were prepared from comb-type graft copolymers P1 to P6. Polymer VP7 was used to obtain polymer composition V13. To this end, each of the comb-type graft copolymers PSA1 to PSA10 and VP7 obtained above was diluted with spirit to a solids content of 30%. Then, the crosslinker stated in Table 3 (either 0.3 wt % of aluminum acetylacetonate (aluminum chelate) (A) or 0.075 wt % of Erisys GA240 (B)) and the resin(s) of table 3 were added to the solution. This was followed by coating onto a 36 μm thick PET film (Kemafoil HPH 100, from Covema) and subsequent drying (coating speed 2.5 m/min, drying tunnel 15 m, temperatures in zone 1: 40° C., zone 2: 70° C., zone 3: 95° C., zone 4: 105° C.). Mass add-on was 50 g/m² in each case.

TABLE 3
Hybrid-type pressure-sensitive adhesive examples PSA1 to PSA10 and also Comparative Examples V11 to V16

| | | | | | | total resin | resin fraction based | proportion of solid |
|---|---|---|---|---|---|---|---|---|
| | | | Regalite R1090 | Piccotac 1095-N | Wingtack 10 | fraction | on macromer | resin in total resin |
| | polymer | crosslinker^{d)} | [%] | [%] | [%] | [%] | [%] | [%] |
| PSA1 | P1 | A | 24.2 | — | 16.2 | 40.4 | 83.3 | 60.0 |
| PSA2 | P2 | A | 23.1 | — | 23.1 | 46.2 | 85.7 | 50.0 |
| PSA3 | P2 | A | 25.8 | — | 22.8 | 48.6 | 86.5 | 53.1 |
| PSA4 | P3 | A | 25.8 | — | 22.8 | 48.6 | 81.0 | 53.1 |
| PSA5 | P4 | A | 24.4 | — | 24.4 | 48.8 | 86.5 | 50 |
| PSA6 | P5 | A | — | 29.4 | 24.3 | 53.7 | 83.0 | 54.8 |
| PSA7 | P5 | A | — | 28.2 | 23.8 | 52.0 | 82.4 | 54.3 |
| PSA8 | P5 | A | — | 27.1 | 22.7 | 49.8 | 81.5 | 54.5 |
| PSA9 | P5 | B | — | 27.1 | 22.7 | 49.8 | 81.5 | 54.5 |
| PSA10 | P6 | A | — | 27.1 | 22.7 | 49.8 | 81.5 | 54.5 |
| V11 | P1 | A | 30.0 | — | — | 30.0 | 75.0 | 100.0 |
| V12 | P3 | B | 21.1 | — | 14.0 | 35.1 | 72.7 | 60.0 |
| V13 | VP7 | A | — | 24.0 | 16.0 | 40.0 | 63.4 | 60.0 |

^{d)}crosslinker A: 0.3 wt % of aluminum chelate, crosslinker B: 0.075 wt % of Erisys GA240.

All adhesion performance data of Examples PSA1 to PSA10 and of the comparative examples are itemized in table 4.

TABLE 4
Adhesion performance data of multiphase polymer compositions
PSA1 to PSA10 and of Comparative Examples V11 to V14

| | BS instant, | BS instant, | BS instant, | |
|---|---|---|---|---|
| | steel | FF-79 | PE | HP RT |
| Ex. | [N/cm] | [N/cm] | [N/cm] | [min] |
| PSA 1 | 9.54 | 8.28 | 4.62 | 10 000 |
| PSA 2 | 11.97 | 8.89 | 6.98 | 10 000 |
| PSA 3 | 12.79 | 10.52 | 7.02 | 10 000 |
| PSA 4 | 10.40 | 9.14 | 6.16 | 10 000 |
| PSA 5 | 12.71 | 9.12 | 2.94 | 10 000 |
| PSA 6 | 14.54 | 14.02 | 6.55 | 5905 (K) |
| PSA 7 | 15.12 | 14.94 | 8.6 | 7464 (K) |
| PSA 8 | 15.74 | 15.39 | 7.56 | 7108 (K) |
| PSA 9 | 14.12 | 13.38 | 7.22 | 10 000 |
| PSA 10 | 7.68 | 7.88 | 4.01 | 10 000 |
| V11 | 7.18 | 3.84 | 2.60 | 3682 (A) |
| V12 | 8.40 | 4.02 | 3.18 | 7246 (A) |
| V13 | 7.02 | 4.13 (R) | 1.23 (R) | 10 000 |

Bond strength (BS) instant was measured as per measurement method H1; holding power (HP) at room temperature was measured as per measurement method H2.
(A): adhesive failure,
(K): cohesive failure,
(R): slip stick failure.

Comparative Examples V11 and V12 illustrate the combination of comb-type graft copolymers (A) with an unfavorable amount of hydrocarbon compounds (B-1) and (B-2). The use of hybrid polymers having too high an acrylic acid concentration leads to a dramatic decrease in bond strengths on the tested apolar surfaces PE and the varnish FF-79 (V 13).

1. A multiphase polymer composition comprising
30-64 parts by weight of a comb-type graft copolymer (A) which is obtainable by polymerizing a comonomer mixture in the presence of at least one macromer selected from the group consisting of polymerizable ethylene-butylene, ethylene-propylene, ethylene-butylene-propylene and isobutylene macromers, and which forms a continuous acrylate phase and a discontinuous hydrocarbon phase Kw; and
36-70 parts by weight of at least two hydrocarbon compounds (B-1) and (B-2) soluble in said hydrocarbon phase Kw of said comb-type graft copolymer (A);
wherein the comonomer mixture comprises: 2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method, of more than 40° C.; and 43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method of 40° C. or less; and
wherein the at least two hydrocarbon compounds comprise a hydrocarbon resin (B-1) having a softening point of at least 70° C. and a hydrocarbon resin (B-2) having a softening point of at most 20° C.

2. The polymer composition as claimed in claim 1, wherein said comb-type graft copolymer (A) is obtainable via polymerization from a mixture comprising 50-99 weight percent of the comonomer mixture and also 1-50 weight percent of the macromer, based on the combined weight of the comonomer mixture and of the at least one macromer.

3. The polymer composition as claimed in claim 1, wherein the comonomer mixture contains 2-7 weight percent, based on the combined weight of the comonomer mixture and of the at least one macromer, of at least one comonomer selected from the group consisting of acrylic acid, methacrylic acid, itaconic acid, itaconic anhydride, maleic acid, and maleic anhydride; and 43-97 weight percent, based on the combined weight of the comonomer mixture and of the at least one macromer, of at least two (meth)acrylate comonomers selected from the group consisting of (meth)acrylate comonomers having a C1-C18 alkyl moiety in the ester group.

4. The polymer composition as claimed in claim 1, wherein the comonomer mixture comprises 2-7 weight percent of acrylic acid, based on the combined weight of the comonomer mixture and of the at least one macromer.

5. The polymer composition as claimed in claim 1, wherein the comonomer mixture further comprises up to 20 weight percent of at least one further copolymerizable monomer selected from the group consisting of isobornyl acrylate, stearyl acrylate, isostearyl acrylate, hydroxyethyl acrylate, hydroxyethyl methacrylate, 4-hydroxybutyl acrylate, vinyl acetate, vinyl butyrate, vinyl propionate, vinyl isobutyrate, vinyl valerate, vinyl versatate, N-vinylpyrollidone and N-vinylcaprolactam.

6. The polymer composition as claimed in claim 1, wherein the polymerization of the comonomer mixture is carried out in the presence of at least one further, non-polyolefinic macromer.

7. The polymer composition as claimed in claim 1, wherein the weight ratio of the hydrocarbon resins (B-1) and (B-2), (B-1):(B-2), is 41:59 to 70:30.

8. The polymer composition as claimed in claim 1, wherein said hydrocarbon resins (B-1) and (B-2) each have a number average molecular weight (Mn) of 1000 g/mol or less, as determined by the GPC method.

9. The polymer composition as claimed in claim 1, wherein the polymer composition additionally contains a hydrocarbon compound (C) whose number average molecular weight (Mn) is more than 1000 g/mol, as determined by the GPC method.

10. The polymer composition as claimed in claim 1, wherein the polymer composition comprises at least one additive selected from the group consisting of plasticizers, and oils and resins soluble in the acrylate phase of the comb-type graft copolymer.

11. The polymer composition as claimed in claim 1, wherein the comonomer mixture contains no hydroxyalkyl (meth)acrylate.

12. A method of preparing a multiphase polymer composition as claimed in claim 1, said method comprising the steps of
polymerizing a comonomer mixture in the presence of at least one macromer selected from the group consisting of polymerizable ethylene-butylene, ethylene-propylene, ethylene-butylene-propylene and isobutylene macromers to form a comb-type graft copolymer (A) having an acrylate main chain and hydrocarbon side chains, wherein the comonomer mixture comprises:
2-7 weight percent, based on the combined weight of the comonomer mixture and of the at least one macromer, of at least one comonomer selected from the group consisting of acrylic acid, methacrylic acid, itaconic acid, itaconic anhydride, maleic acid, maleic anhydride and further monomers whose homopolymers have a static glass transition temperature (Tg), as measured by the DSC method, of more than 40° C.; and
43-97 weight percent, based on the combined weight of the comonomer mixture and of the at least one macromer, of at least two (meth)acrylate comonomers selected from the group consisting of monomers whose homopolymers have a static glass transition temperature (Tg), as measured by the DSC method of 40° C. or less;
mixing 30-64 parts by weight of said comb-type graft copolymer (A) thus obtained with 36-70 parts by weight, based on 100 parts by weight of the polymer composition, of at least two hydrocarbon compounds (B-1 and (B-2) which are compatible with the hydrocarbon side chains of said comb-type graft copolymer (A), wherein (B-1) is a hydrocarbon resin having a softening point of at least 70° C. and (B-2) is a hydrocarbon resin having a softening point of at most 20° C.

13. A pressure-sensitive adhesive comprising a multiphase polymer composition of claim 1.

14. A method of bonding articles wherein said articles are bonded with the pressure-sensitive adhesive of claim 13.
